(19) United States
(12) Patent Application Publication
(10) Pub. No.: US 2019/0032626 A1
(43) Pub. Date: Jan. 31, 2019

(54) Wave Power Generator

(71) Applicant: Fan Liu, Zhuhai (CN)

(72) Inventor: Fan Liu, Zhuhai (CN)

(21) Appl. No.: 15/662,326

(22) Filed: Jul. 28, 2017

(51) Int. Cl. F03B 13/14; F16H 19/06; F16H 31/00

(52) U.S. Cl. CPC F03B 13/14; F16H 19/06; F16H 31/001; F05B 2260/4021; F05B 2240/931; F05B 2260/4031; F05B 2260/4023; F05B 2220/706

(57) ABSTRACT

A wave power generator contains: a rotary shaft, a drive gear, a rotary accelerator, and a power generation set. The rotary shaft includes a first gear set fixed by using a first bearing and includes a second gear set mounted by using a second bearing, and a fixing direction of the first bearing is opposite to the second bearing. The drive gear is disposed on the rotary shaft so as to drive the rotary shaft to rotate reciprocately, wherein a chain is connected with the drive gear so as to pull a floating member to move reciprocately. A first end of the rotary accelerator is joined with the first gear set, and a second end of the rotary accelerator is coupled with the second gear set via a clutch gear. An input end of the power generation set is in connection with an output shaft of the rotary accelerator.

### FIELD OF THE INVENTION

The present invention relates to a wave power generator which is mounted along a coast so as to produce huge electricity by way of the waves.

### BACKGROUND OF THE INVENTION

Electricity produces by way of firepower, wind power, gasoline, diesel and nuclear power, but these energy sources are limited. In addition, a nuclear power generation station occupies a large space and discharges scraps, waste waters, and waste gases to cause environmental pollution. When the electricity is generated by oils, coals and natural gases, huge amount of carbon dioxide enhances global temperature to cause natural disaster. To reduce a discharge of carbon dioxide, waves and solar energy are employed to generate the electricity. However, the solar energy is gathered by lots of solar panels.

To solve above-mentioned defects, the waves are applied to generate the electricity currently, yet it destroys power generation facilities easily. Furthermore, as fixing a conventional wave power generator on a ship or on a seabed, cables transmit the electricity in a long time and at limited quantity.

The present invention has arisen to mitigate and/or obviate the afore-described disadvantages.

### SUMMARY OF THE INVENTION

The primary objective of the present invention is to provide a wave power generator which is mounted along a coast so as to produce huge electricity by way of the waves.

To obtain above-mentioned objective, a wave power generator provided by the present invention contains: a rotary shaft, a drive gear, a rotary accelerator, and a power generation set.

The rotary shaft includes a first gear set fixed on a first end thereof by using a first bearing, and the rotary shaft includes a second gear set mounted on a second end thereof by using a second bearing, wherein a fixing direction of the first bearing is opposite to that of the second bearing.

The drive gear is disposed on the rotary shaft so as to drive the rotary shaft to rotate reciprocately, wherein a chain is connected with the drive gear so as to pull a floating member to move reciprocately.

A first end of the rotary accelerator is joined with the first gear set, and a second end of the rotary accelerator is coupled with the second gear set via a clutch gear.

An input end of the power generation set is in connection with an output shaft of the rotary accelerator.

Preferably, the wave power generator further contains a fixing pile, a pulley arranged above the fixing pile, and a first steel cable extending across the pulley. A first end of the first steel cable is in connection with a first side of the floating member, a second end of the first steel cable is joined with a first end of the chain, a second side of the floating member is coupled with a first end of the second steel cable, and a second end of the second steel cable is connected with a second end of the chain.

Preferably, the floating member includes a stop plate arranged thereon.

Preferably, the floating member is a ship, and the stop plate is arranged on a middle section of the floating member and extending out of the floating member downwardly.

Preferably, a length of the floating member is 120 in, a width of the floating member is 20 in, a length of the stop plate is equal to that of the floating member, and a height of the stop plate is 5 in more than that of the floating member.

### BRIEF DESCRIPTION OF THE DRAWINGS

FIG. 1 is a schematic view showing the assembly of a wave power generator according to a preferred embodiment of the present invention.

### DETAILED DESCRIPTION OF THE PREFERRED EMBODIMENTS

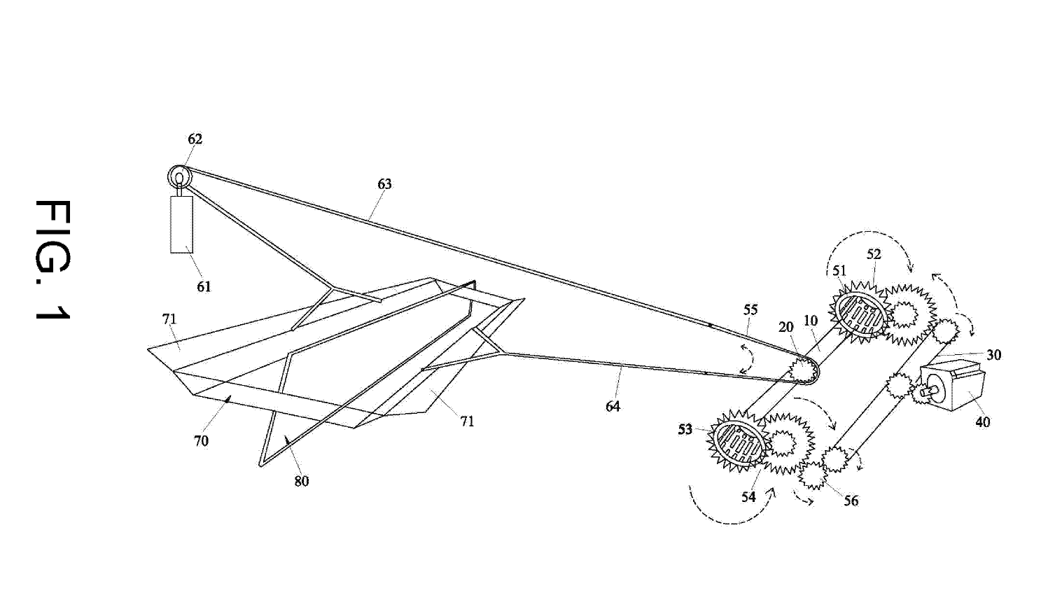

With reference to FIG. 1, a wave power generator according to a preferred embodiment of the present invention comprises: a rotary shaft 10, a drive gear 20, a rotary accelerator 30, and a power generation set 40.

The rotary shaft 10 includes a first gear set 52 fixed on a first end thereof by using a first bearing 51, and the rotary shaft 10 includes a second gear set 54 mounted on a second end thereof by using a second bearing 53, wherein a fixing direction of the first bearing 51 is opposite to that of the second bearing 53.

The drive gear 20 is disposed on the rotary shaft 10 so as to drive the rotary shaft 10 to rotate reciprocately, wherein a chain 55 is connected with the drive gear 20 so as to pull a floating member 70 to move reciprocately.

A first end of the rotary accelerator 30 is joined with the first gear set 52, and a second end of the rotary accelerator 30 is coupled with the second gear set 54 via a clutch gear 56.

An input end of the power generation set 40 is in connection with an output shaft of the rotary accelerator 30.

The wave power generator further comprises a fixing pile 61, a pulley 62 arranged above the fixing pile 61, and a first steel cable 63 extending across the pulley 62, wherein a first end of the first steel cable 63 is in connection with a first side of the floating member 70, a second end of the first steel cable 63 is joined with a first end of the chain 55, a second side of the floating member 70 is coupled with a first end of the second steel cable 64, and a second end of the second steel cable 64 is connected with a second end of the chain 55.

The floating member 70 includes a stop plate 80 arranged thereon, and the stop plate 80 is made of steel. The floating member 70 is a ship, and the stop plate 80 is arranged on a middle section of the floating member 70 and extending out of the floating member 70 downwardly. A length of the floating member 70 is 120 in, and a width of the floating member 70 is 20 in, wherein a length of the stop plate 80 is equal to that of the floating member 70, and a height of the stop plate 80 is 5 in more than that of the floating member 70. The floating member 70 includes two removable inclined sheets 71 extending outwardly from the first and second sides thereof respectively.

In operation, the floating member 70 drives the chain 55 to move back and forth via the first steel cable 63 and the second steel cable 64, and the chain 55 actuates the drive gear 20 to revolve, hence the rotary shaft 10 is driven by the drive gear 20 to rotate, and the second bearing 53 and the first bearing 51 are actuated by the rotary shaft 10 to revolve. When the drive gear 20 rotates in a clockwise direction, the first bearing 51 is driven by the rotary shaft 10 to actuate the first gear set 52 to revolve, such that the rotary accelerator 30 is urged by the first gear set 52 to drive the power generation set 40 to generate electricity. In the meantime, the rotary accelerator 30 removes from the clutch gear 56. When the drive gear 20 rotates in a counterclockwise direction, the second bearing 53 is driven by the rotary shaft 10 to connect with the clutch gear 56, such that the rotary accelerator 30 drives the power generation set 40 to generate the electricity. Thereby, the clutch gear 56 connects with and removes from the rotary accelerator 30 and changes rotation directions of the second bearing 53 and the first bearing 51. Preferably, the clutch gear 56 connects with and drives the power generation set 40 to revolve.

It is assumed that waves drive seawaters of 5 in depth to move 10 in back and forth on a coast of 1 km (i.e. a movement distance of the seawaters is 20 in), it will take 6.66 seconds. Therefore, 5M×10000M×20M×1000KG×9.8N×20M=19600000000 N×M, and 19600000000/6.66=2942942942 watts, thus generating around the electricity of 300 million kilowatts.

When the power of 300 million kilowatts is used at 20% (due to a loss of the electricity produces when the waves strike the floating member or because of a power transmission and an efficiency of the wave power generator), at least 600,000 kilowatts generates. When the wave power generator operates at least 10 hours every day, and a cost of the electricity of 1 kWh is 3 cents, the wave power generator of the present invention earns income of 1.8 million one day.

Accordingly, the wave power generator of the present invention is mounted along the coast to produce huge electricity by way of the waves.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A wave power generator comprising: a rotary shaft, a drive gear, a rotary accelerator, and a power generation set;
the rotary shaft including a first gear set fixed on a first end thereof by using a first bearing, and the rotary shaft including a second gear set mounted on a second end thereof by using a second bearing, wherein a fixing direction of the first bearing is opposite to that of the second bearing;
the drive gear being disposed on the rotary shaft so as to drive the rotary shaft to rotate reciprocately, wherein a chain is connected with the drive gear so as to pull a floating member to move reciprocately;
a first end of the rotary accelerator being joined with the first gear set, and a second end of the rotary accelerator being coupled with the second gear set via a clutch gear;
an input end of the power generation set being in connection with an output shaft of the rotary accelerator.

2. The wave power generator as claimed in claim 1 further comprising a fixing pile, a pulley arranged above the fixing pile, and a first steel cable extending across the pulley, wherein a first end of the first steel cable is in connection with a first side of the floating member, a second end of the first steel cable is joined with a first end of the chain, a second side of the floating member is coupled with a first end of the second steel cable, and a second end of the second steel cable is connected with a second end of the chain.

3. The wave power generator as claimed in claim 1, wherein the floating member includes a stop plate arranged thereon.

4. The wave power generator as claimed in claim 3, wherein the floating member is a ship, and the stop plate is arranged on a middle section of the floating member and extending out of the floating member downwardly.

5. The wave power generator as claimed in claim 4, wherein a length of the floating member is 120 in, a width of the floating member is 20 in, a length of the stop plate is equal to that of the floating member, and a height of the stop plate is 5 in more than that of the floating member.
